(19) United States
(12) Patent Application Publication
(10) Pub. No.: US 2015/0058127 A1
(43) Pub. Date: Feb. 26, 2015

(54) DIRECTIONAL VEHICULAR ADVERTISEMENTS

(71) Applicant: International Business Machines Corporation, Armonk, NY (US)

(72) Inventors: Kelly N. Abuelsaad, Somers, NY (US); Lisa Seacat DeLuca, Baltimore, MD (US); Soobaek Jang, Hamden, CT (US); Daniel C. Krook, Fairfield, CT (US)

(73) Assignee: International Business Machines Corporation, Armonk, NY (US)

(21) Appl. No.: 13/975,801

(22) Filed: Aug. 26, 2013

(51) Int. Cl. G06Q 30/02; G09F 21/04

(52) U.S. Cl. CPC G06Q 30/0266; G09F 21/048
USPC 705/14.63

(57) ABSTRACT

Directional vehicular advertisements displayed on a vehicle. A system in accordance with an embodiment includes: a location system for determining a location and a direction of travel of a vehicle; at least one forward facing advertisement slot on the vehicle, wherein each forward facing advertisement slot faces oncoming traffic travelling in a direction opposite to the direction of travel of the vehicle; a plurality of advertisements, each advertisement associated with a location; and a controller configured to select and display at least one of the advertisements via at least one of the forward facing advertisement slots, wherein each displayed advertisement is associated with a location that the oncoming traffic has yet to pass.

### TECHNICAL FIELD

The present invention relates generally to advertisements, and more particularly, to directional vehicular advertisements that are selected and displayed based on the location and direction of travel of a vehicle and the orientation of the advertisements on the vehicle.

### RELATED ART

Drivers and passengers of moving vehicles are commonly exposed to a large number of advertisements. Advertisements appear on billboards, buildings, on the top and/or sides of vehicles, and even on people. Many advertisements, such as those found on billboards, are static and are periodically changed. Other advertisements are dynamic and mounted on vehicles, allowing for more interactive and/or targeted advertisements.

### SUMMARY

A first aspect of the invention provides a system for providing and displaying directional vehicular advertisements, comprising: a location system for determining a location and a direction of travel of a vehicle; at least one forward facing advertisement slot on the vehicle, wherein each forward facing advertisement slot faces oncoming traffic travelling in a direction opposite to the direction of travel of the vehicle; a plurality of advertisements, each advertisement associated with a location; and a controller configured to select and display at least one of the advertisements via at least one of the forward facing advertisement slots, wherein each displayed advertisement is associated with a location that the oncoming traffic has yet to pass.

A second aspect of the invention provides a method for providing and displaying directional vehicular advertisements, comprising: determining a location and a direction of travel of a vehicle; providing at least one forward facing advertisement slot on the vehicle, wherein each forward facing advertisement slot faces oncoming traffic travelling in a direction opposite to the direction of travel of the vehicle; providing a plurality of advertisements, each advertisement associated with a location; and selecting and displaying at least one of the advertisements via at least one of the forward facing advertisement slots, wherein each displayed advertisement is associated with a location that the oncoming traffic has yet to pass.

A third aspect of the invention provides a system, comprising: a vehicle; a location system for determining a location and a direction of travel of the vehicle; at least one forward facing advertisement slot on the vehicle, wherein each forward facing advertisement slot faces oncoming traffic travelling in a direction opposite to the direction of travel of the vehicle; a plurality of advertisements, each advertisement associated with a location; and a controller configured to select and display at least one of the advertisements via at least one of the forward facing advertisement slots, wherein each displayed advertisement is associated with a location that the oncoming traffic has yet to pass.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1a depicts a front view of a vehicle with directional vehicular advertisements according to an embodiment.

FIG. 1b depicts a rear view of the vehicle of FIG. 1a according to an embodiment.

FIG. 1c depicts a first side view of the vehicle of FIG. 1a according to an embodiment.

FIG. 1d depicts a second side view of the vehicle of FIG. 1a according to an embodiment.

FIG. 2 depicts an illustrative control system for selecting and displaying advertisements according to an embodiment.

FIG. 3 depicts a flow diagram of an illustrative process for selecting and displaying advertisements based on the location and direction of travel of a vehicle and the orientation of the advertisement slots on the vehicle in accordance with an embodiment.

FIG. 4 depicts a map-based example of a process for selecting and displaying advertisements based on the location and direction of travel of a vehicle and the orientation of the advertisement slots on the vehicle in accordance with an embodiment.

FIG. 5 depicts another map-based example of a process for selecting and displaying advertisements based on the location and direction of travel of a vehicle and the orientation of the advertisement slots on the vehicle in accordance with an embodiment.

FIG. 6 depicts another map-based example of a process for selecting and displaying advertisements based on the location and direction of travel of a vehicle and the orientation of the advertisement slots on the vehicle in accordance with an embodiment.

FIG. 7 shows an illustrative environment for providing directional vehicular advertisements according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION

The present invention relates generally to advertisements, and more particularly, to directional vehicular advertisements that are selected and displayed based on the location and direction of travel of a vehicle and the orientation of the advertisements on the vehicle. As used herein, unless otherwise noted, the term “set” means one or more (i.e., at least one) and the phrase “any solution” means any now known or later developed solution.

A vehicle is provided with at least one advertisement slot, with each advertisement slot including a display device for displaying an advertisement. In embodiments of the present invention, at least one advertisement slot faces forward on the vehicle. In other embodiments, the vehicle may also include at least one rearward facing advertisement slot and/or at least one sideways facing advertisement slot.

The best matching advertisements are dynamically displayed via one or more of the advertisement slots on the vehicle, and are selected, for example, based on the location and direction of travel of the vehicle and the direction each of the advertisement slots is facing. By selecting and displayed advertisements in this manner, the present invention increases the advertising effectiveness of the vehicle by targeting the advertisements to the drivers of other vehicles headed in the direction of the event/venue/business/etc., associated with the advertisements. Further, the number of wasted advertisements on events/venues/businesses/etc. that are not near a person's destination or on their intended travel path is reduced.

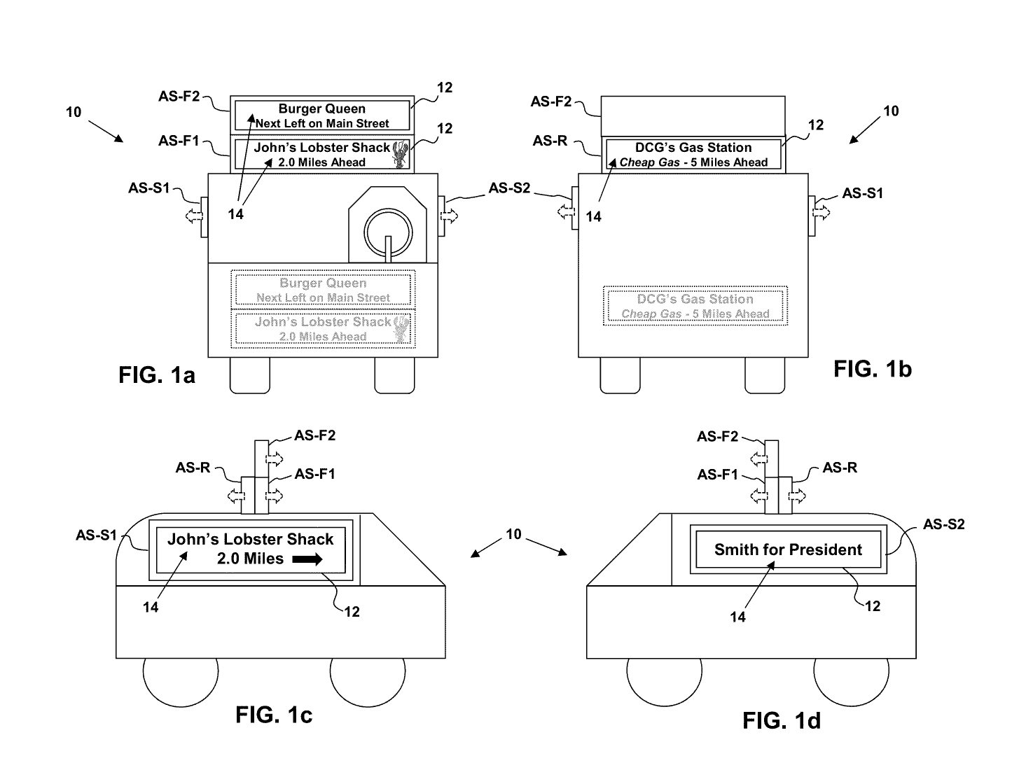

An illustrative vehicle 10 configured in accordance with an embodiment of the present invention is depicted in FIGS. 1a-1d. FIG. 1a shows a front view of the vehicle 10, FIG. 1b shows a rear view of the vehicle 10, FIG. 1c shows a first side view of the vehicle 10, and FIG. 1d shows a second side view of the vehicle 10. Although depicted as a van, the vehicle 10 may comprise any type of movable object capable of including advertisement slots that are oriented and operate in accordance with embodiments of the present invention. The vehicle 10 may comprise, for example, an automobile, truck, taxi, bus, train, bicycle, motorcycle or scooter, boat, blimp, motor-home, train, and/or the like. A person carrying advertisement slots (e.g., on a t-shirt, sandwich board, etc.) may also be considered a vehicle 10 according to embodiments of the invention.

As depicted in FIGS. 1a-1d, a vehicle 10 may be provided with a plurality of advertisement slots (AS). In this example, the vehicle 10 includes a first forward facing advertisement slot AS-F1, a second forward facing advertisement slot AS-F2, a rearward facing advertisement slot AS-R, a sideways facing advertisement slot AS-S1 located on a first side of the vehicle 10, and a sideways facing advertisement slot AS-S2 located on a second side of the vehicle 10. Each advertisement slot AS may be mounted to, integrated in, or otherwise coupled to the vehicle 10. For example, as shown in FIGS. 1a-1d, the first and second forward facing advertisement slots AS-F1, AS-F2, as well as the rearward facing slot AS-R, may be mounted on top of the vehicle 10. In other embodiments, however, these advertisement slots may, for example, be mounted on the front and rear sections of the vehicle 10, as indicated in phantom in FIGS. 1a, 1b. Further, although the first and second sideways facing advertisement slots AS-S1, AS-S2 are shown mounted on the sides of the vehicle 10, these advertisement slots may, for example, be mounted on the top of the vehicle. Other advertisement slot AS mounting/positioning options are also possible.

In the embodiment depicted in FIGS. 1a-1d, the vehicle 10 includes a plurality of forward facing advertisement slots AS-F1, AS-F2, a single rearward facing advertisement slot AS-R, and a plurality of sideways facing advertisement slots AS-S1, AS-S2. In general, however, one or more forward facing advertisement slots AS-F, zero or more rearward facing advertisement slots AS-R, and zero or more sideways facing advertisement slots AS-S may be provided in accordance with various embodiments.

As depicted in FIGS. 1a-1d, each advertisement slot AS includes an electronic display device 12 for displaying an advertisement 14. To this extent, the display device 12 of a forward facing advertisement slot AS-F displays an advertisement 14 towards the front of the vehicle 10 (i.e., in a forward direction), a rearward facing advertisement slot AS-R displays an advertisement 14 towards the rear of the vehicle 10 (i.e., in a rearward direction), and a sideways facing advertisement slot AS-S displays an advertisement 14 towards a side of the vehicle 10. Thus, in an embodiment, the direction in which an advertisement 14 is displayed by a display device 12 of an advertisement slot AS is dictated by the direction in which that advertisement slot AS is facing on the vehicle 10.

The display device 12 may take many different forms including, for example, a liquid crystal display (LCD) display device, a thin-film-transistor liquid crystal display (TFT LCD) display device, a light emitting diode (LED) display device, an organic light emitting diode (OLED) display device, a plasma display device, a projection display device, a cathode ray tube (CRT) display device, an optical fiber screen display device, or any other type of device capable of displaying digital data.

In FIG. 1a, each frontward facing advertisement slot AS-F1, AS-F2 includes its own, dedicated display device 12. However, different portions of the same display device 12 can be shared by multiple advertisement slots AS facing in the same direction. Further, a single advertisement slot AS and display device 12 combination may be configured (or split into) a plurality of sections, with each section capable of displaying a different advertisement 14. Other configurations are also possible.

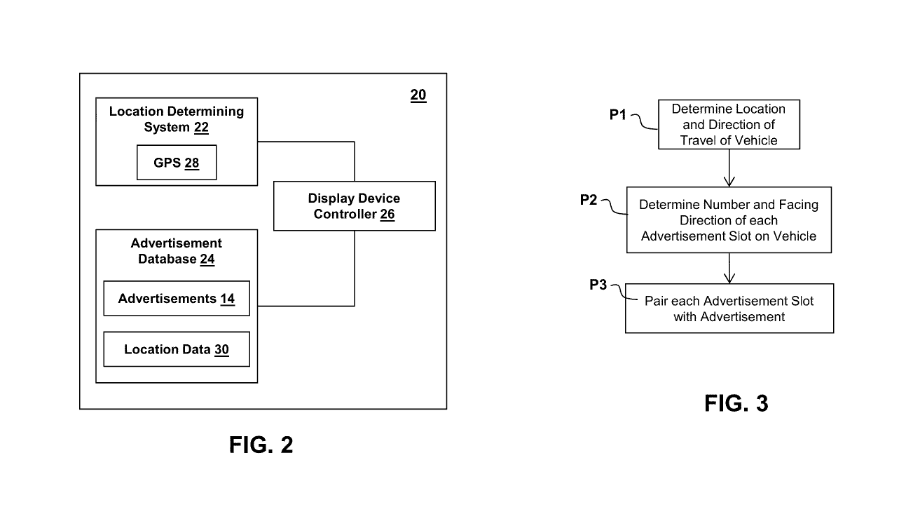

According to embodiments, the best matching advertisements 14 are selected and dynamically displayed via the advertisement slots AS on the vehicle 10 based, for example, on the location and direction of travel of the vehicle 10 and the direction each of the advertisement slots AS is facing. As shown in FIG. 2, a control system 20 may be provided for selecting and displaying the best matching advertisements 14. The control system 20, which may be located, for example, in or on the vehicle 10, includes a location determining system 22, an advertisement database 24, and a display device controller 26.

The location determining system 22 is configured to determine the geographical location of the vehicle 10 and the direction in which the vehicle 10 is traveling. In an embodiment, the location determining system 22 includes a global positioning system (GPS) receiver 28 that operates in a manner known in the art to determine the geographical location of the vehicle 10 and the direction in which the vehicle 10 is traveling. Other techniques for determining the geographical location of the vehicle 10 and the direction in which the vehicle 10 is traveling may also be employed. Such techniques may include, for example, triangulation using radio or cellular signals, signpost location systems, and/or the like.

The advertisement database 24 stores a set of advertisements 14 that may be selectively displayed in the advertisement slots AS of the vehicle 10 based on the location and direction information of the vehicle 10 provided by the location determining system 22 and the direction each advertisement slot AS is facing on the vehicle 10. The advertisements 14 stored in the advertisement database 24 may be associated, without limitation, with goods, services, businesses, restaurants, venues, events, and/or the like. The advertisement database 24 may also include location data 30 corresponding to the stored advertisements 14. For example, the location data 30 for a given advertisement 14 may indicate that the advertisement 14 is related to:

1) a specific location (e.g., “Burger Queen” or “John's Lobster Shack” (as shown in FIG. 1a)), or address (e.g., 124 West Main Street, Smallville, N.Y.);
2) a set of locations, where there are multiple locations (e.g., a national chain of gas stations, restaurants, etc.); and
3) no particular location (e.g., a political campaign (as shown in FIG. 1d), a product, and/or the like).

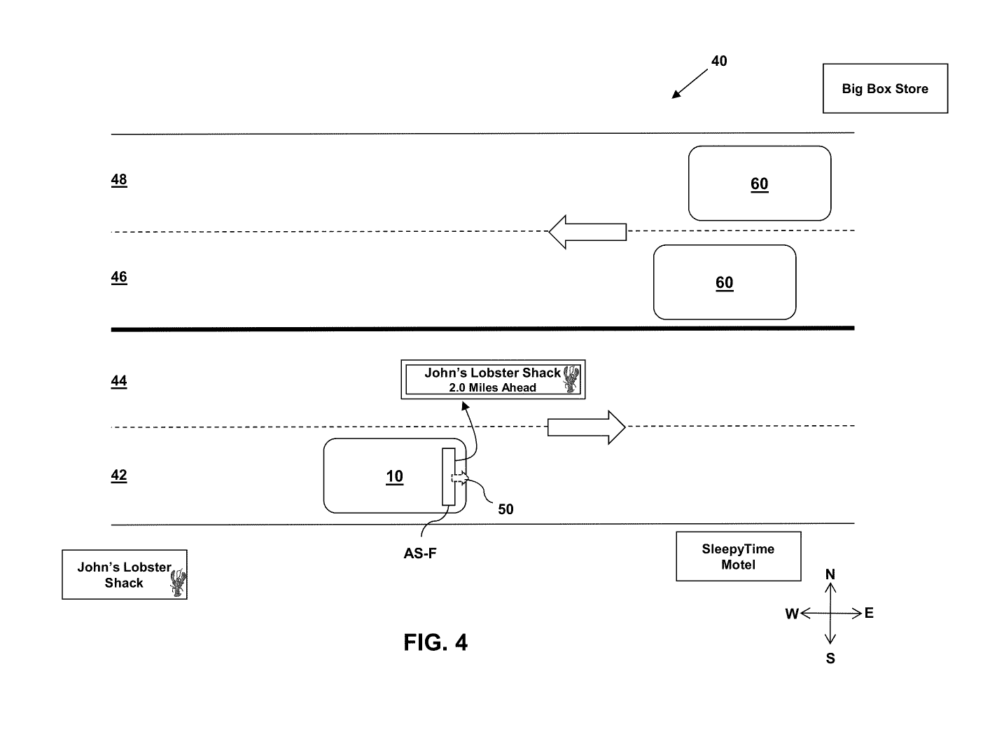

A flow diagram of an illustrative process for selecting and displaying advertisements 14 based on the location and direction of travel of a vehicle 10 and the orientation (e.g., facing direction) of the advertisement slots AS on the vehicle 10 in accordance with an embodiment is depicted in FIG. 3, with continued reference to FIGS. 1 and 2. Map-based examples of the process are depicted in FIGS. 4-6.

At P1, the location and direction of travel of the vehicle 10 is determined via the GPS receiver 28 of the location determining system 22. At P2, the number of advertisement slots AS available on the vehicle 10 and direction each advertisement slot AS is facing on the vehicle 10 are determined. At P3, based on the data provided in P1 and P2, and the particular advertisements 14 and location data 30 associated therewith stored in the advertisement database 24, the display device controller 26 pairs each advertisement slot AS with at least one advertisement 14. A first map-based example of this process is shown in FIG. 4.

A four lane road 40, with two eastbound lanes 42, 44, and two westbound lanes 46, 48, is depicted in FIG. 4. A vehicle 10, which includes a frontward facing advertisement slot AS-F, is determined to be traveling eastward in lane 42 of the road 40 by the GPS receiver 28 of the location determining system 22. To this extent, the frontward facing advertisement slot AS-F is also facing eastward (arrow 50) and thus can be seen by oncoming traffic 60 traveling westward in lanes 46, 48 of the road 40. Although described as including a plurality of lanes in each direction, the road 40 may, in general, include any number of lanes.

Since the frontward facing advertisement slot AS-F is facing the oncoming traffic 60, the display device controller 26 selects one or more advertisements 14 from the advertisement database 24 associated with specific locations that the oncoming traffic 60 has yet to pass. The display device controller 26 then displays one or more of the selected advertisements 14 on the display device 12 of the frontward facing advertisement slot AS-F.

In this example, John's Lobster Shack is physically located to the west of the current location of the vehicle 10, which is moving to the east, away from the location of the restaurant. Based on the current location and direction of travel of the vehicle 10, as well as the forward facing direction of the advertisement slot AS-F on the vehicle 10, the display device controller 26 selects one or more advertisements 14 from the advertisement database 24 associated with locations (e.g., John's Lobster Shack) that the oncoming traffic 60 has yet to pass. The display device controller 26 then displays the selected advertisements 14 (and optionally distance/direction information) on the display device 12 of the frontward facing advertisement slot AS-F. Each of the selected advertisements 14 displayed via the frontward facing advertisement slot AS-F is visible to the westbound oncoming traffic 60 approaching the vehicle 10 on the other side of the road 40. Since the oncoming traffic 60 has yet to pass the upcoming restaurant (John's Lobster Shack) associated with the currently displayed advertisement 14, drivers can now easily modify their intended route or end destination before passing John's Lobster Shack and enjoy a tasty meal.

In an embodiment, the vehicle 10 may continue to display a given advertisement 14 (e.g., for John's Lobster Shack) on the frontward facing advertisement slot AS-F until the vehicle 10 is a predetermined distance (e.g. 20 miles) from the location associated with the advertisement 14. In other embodiments, the vehicle 10 may continue to display a given advertisement 14 on the frontward facing advertisement slot AS-F until the vehicle 10 changes its direction or travel route. Further, another advertisement 14 may take precedence, for example, if the vehicle 10 passes a location associated with another event/venue/business/etc for which an advertisement 14 has been stored in the advertisement database 24. In this case, a different advertisement 14, associated with that location, may be selected and displayed to oncoming traffic 60 via the frontward facing advertisement slot AS-F. Other advertisement slots AS on the vehicle may operate in a similar manner.

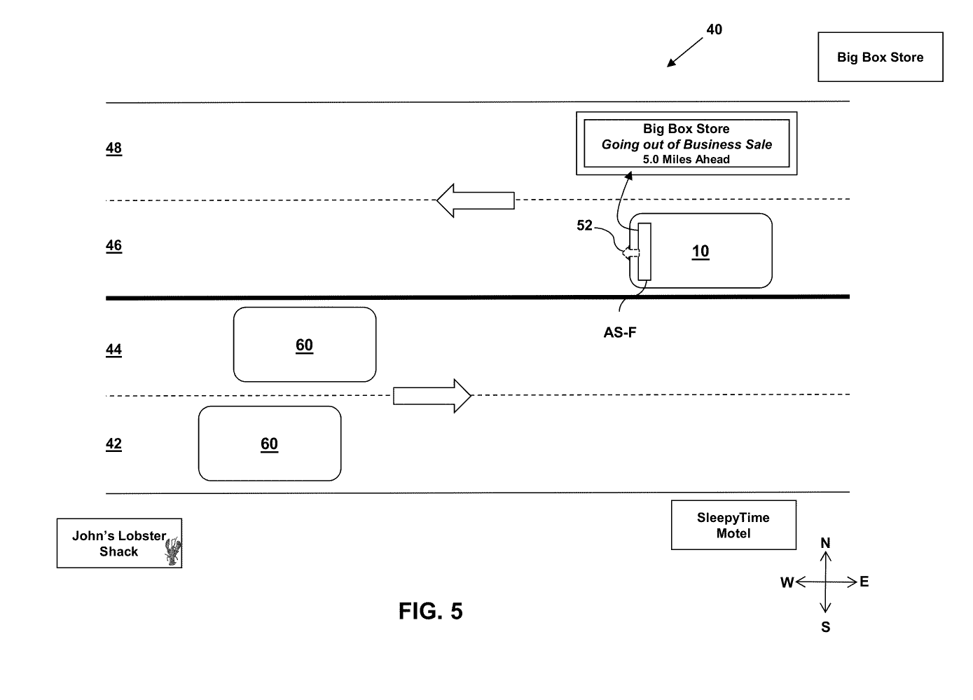

At a later time, as depicted in FIG. 5, the vehicle 10 is detected traveling westward in lane 46 of the road 40 by the GPS receiver 28 of the location determining system 22. As such, the frontward facing advertisement slot AS-F is now also facing westward (arrow 52) and thus can be seen by oncoming traffic 60 traveling eastward in lanes 42, 44 of the road 40. Since the frontward facing advertisement slot AS-F is facing the oncoming traffic 60, the display device controller 26 selects one or more advertisements 14 from the advertisement database 24 associated with specific locations that the oncoming traffic 60 has yet to pass. The display device controller 26 then displays one or more of the selected advertisements 14 on the display device 12 of the frontward facing advertisement slot AS-F.

In this example, the vehicle 10 no longer displays an advertisement 14 for John's Lobster Shack as it did when it was located in a similar location but traveling eastward in the opposite direction. Instead, based on the current location and direction of travel of the vehicle 10, as well as the forward facing direction of the advertisement slot AS-F on the vehicle 10, the display device controller 26 selects one or more advertisements 14 (e.g., Big Box Store) from the advertisement database 24 associated with locations the oncoming traffic 60 has yet to pass. The display device controller 26 then displays the selected advertisements 14 (and optionally distance/direction information) on the display device 12 of the frontward facing advertisement slot AS-F. Each of the selected advertisements 14 displayed via the frontward facing advertisement slot AS-F is visible to the oncoming eastbound traffic 60 approaching the vehicle 10 on the other side of the road 40. Since the oncoming traffic 60 has yet to pass the upcoming location (e.g., Big Box Store) associated with the currently displayed advertisement 14, drivers can now easily modify their intended route or end destination to arrive at the Big Box Store to participate in its “Going out of Business Sale.”

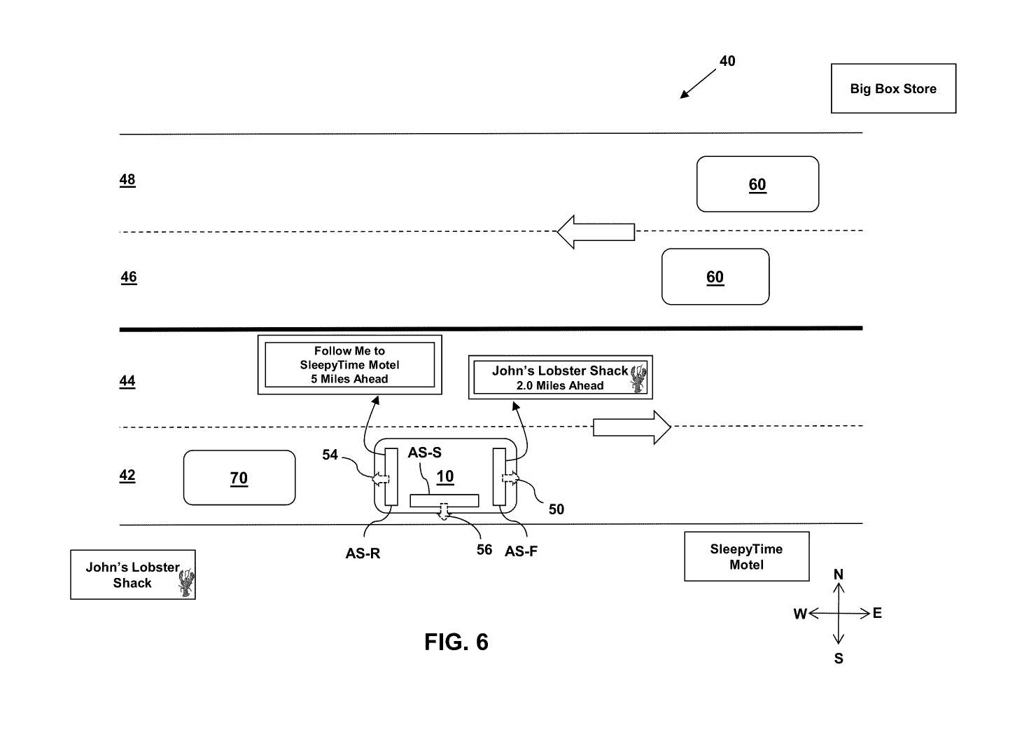

In yet another example, as shown in FIG. 6, the vehicle 10 includes both a frontward facing advertisement slot AS-F and a rearward facing advertisement slot AS-R. In addition, the vehicle 10 includes a sideways facing advertisement slot AS-S, which faces southward (arrow 54) in this example.

The frontward facing advertisement slot AS-F, which faces the oncoming traffic 60, displays (arrow 50) one or more advertisements 14 (e.g., for John's Lobster Shack) in a manner similar to that discussed above with regard to FIG. 4. The rearward facing advertisement slot AS-R, which faces traffic 70 traveling behind and in the same direction as the vehicle 10, displays (arrow 54) one or more advertisements 14 associated with locations that the vehicle 10 and trailing traffic 70 have yet to pass while traveling eastward along the road 40. In this example, the advertisement 14 currently being displayed is associated with the SleepyTime Motel. The one or more advertisements 14 displayed by the rearward facing advertisement slot AS-R are selected by the display device controller 26 from the advertisement database 24.

The sideways facing advertisement slot AS-S depicted in FIG. 6 can be used to display (arrow 56) many different types of advertisements 14. A sideways facing advertisement slot AS-S can display an advertisement 14 that can be seen, for example, by: vehicles passing in either direction past the vehicle 10; pedestrians walking or located along the road 40; and vehicles pulling onto the road 40. In an embodiment, the advertisement 14 displayed by the sideways facing advertisement slot AS-S may not be associated with any particular location (see, e.g., FIG. 1d) or may be randomly selected from the advertisement database 24. In another embodiment, the advertisement 14 displayed by the sideways facing advertisement slot AS-S may be selected based on proximity to the vehicle 10. For instance, if the vehicle 10 is located one block from John's Lobster Shack, the sideways facing advertisement slot AS-S may display the advertisement 14 for John's Lobster Shack regardless of which direction the vehicle 10 is traveling. In yet another embodiment, a camera mounted to the vehicle may be used to determine the walking/running direction of the pedestrians on a sidewalk adjacent a road. In this case, the sideways facing advertisement slot AS-S may display an advertisement 14 based on the movement of the pedestrians.

In another embodiment, the frontward facing advertisement slot AS-F on the vehicle 10 may be configured to display an advertisement 14 using reversed text that can be read in a rearview mirror of a vehicle traveling in front of the vehicle 10. In this case, the advertisement 14 will be selected based on a location that the vehicle 10 and leading traffic have yet to pass while traveling in the same direction along the road 40.

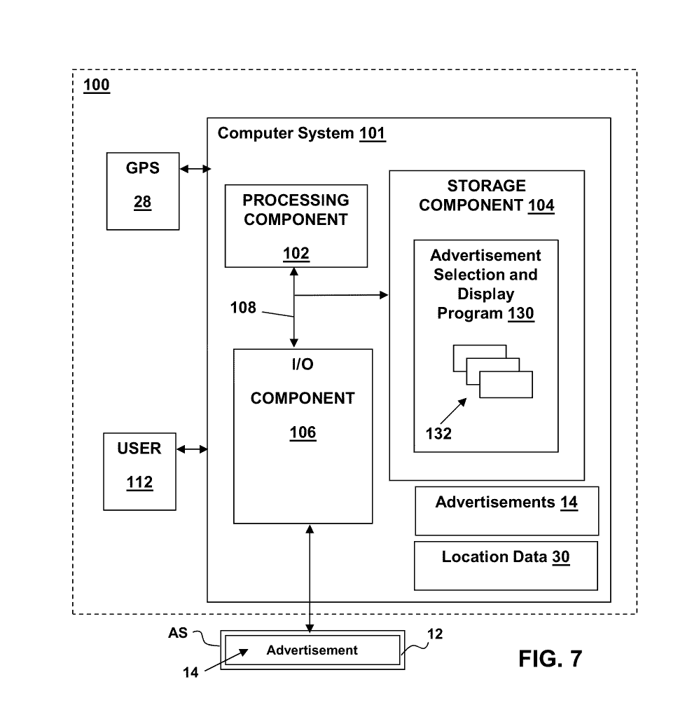

An illustrative environment 100 for providing directional vehicular advertisements is shown in FIG. 7. The environment 100 includes at least one computer system 101 and an advertisement selection and display program 130 that can perform processes described herein (e.g., as described with regard to FIGS. 2 and 3 and the examples shown in FIGS. 4-6) in order to provide directional vehicular advertisements according to embodiments.

The computer system 101 is shown including a processing component 102 (e.g., one or more processors), a storage component 104 (e.g., a storage hierarchy), an input/output (I/O) component 106 (e.g., one or more I/O interfaces and/or devices), and a communications pathway 108. In general, the processing component 102 executes program code, such as the advertisement selection and display program 130, which is at least partially fixed in the storage component 104. While executing program code, the processing component 102 can process data, such as advertisements 14, location data 30, GPS data provided by a GPS receiver 28, and/or the like, which can result in reading and/or writing transformed data from/to the storage component 104 and/or the I/O component 106 for further processing. The pathway 108 provides a communications link between each of the components in the computer system 101. The I/O component 106 can include one or more human I/O devices, which enable a human user 112 to interact with the computer system 101 and/or one or more communications devices to enable a system user 112 to communicate with the computer system 101 using any type of communications link. To this extent, the advertisement selection and display program 130 can manage a set of interfaces (e.g., graphical user interface(s), application program interfaces, and/or the like) that enable human and/or system users 112 to interact with the advertisement selection and display program 130. Furthermore, the advertisement selection and display program 130 can manage (e.g., store, retrieve, create, manipulate, organize, present, etc.) data, using any solution.

The computer system 101 can include one or more general purpose computing articles of manufacture (e.g., computing devices) capable of executing program code, such as the advertisement selection and display program 130, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the advertisement selection and display program 130 can be embodied as any combination of system software and/or application software.

Furthermore, the advertisement selection and display program 130 can be implemented using a set of modules 132. In this case, a module 132 can enable the computer system 101 to perform a set of tasks used by the advertisement selection and display program 130, and can be separately developed and/or implemented apart from other portions of the advertisement selection and display program 130. As used herein, the term “component” means any configuration of hardware, with or without software, which implements the functionality described in conjunction therewith using any solution, while the term “module” means program code that enables a computer system 101 to implement the actions described in conjunction therewith using any solution. When fixed in a storage component 104 of a computer system 101 that includes a processing component 102, a module is a portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computer system 101.

When the computer system 101 includes multiple computing devices, each computing device can have only a portion of the advertisement selection and display program 130 fixed thereon (e.g., one or more modules 132). However, it is understood that the computer system 101 and the advertisement selection and display program 130 are only representative of various possible equivalent computer systems that may perform a process described herein. To this extent, in other embodiments, the functionality provided by the computer system 101 and the advertisement selection and display program 130 can be at least partially implemented by one or more computing devices that include any combination of general and/or specific purpose hardware with or without program code. In each embodiment, the hardware and program code, if included, can be created using standard engineering and programming techniques, respectively.

When the computer system 101 includes multiple computing devices, the computing devices can communicate over any type of communications link. Furthermore, while performing a process described herein, the computer system 101 can communicate with one or more other computer systems using any type of communications link. In either case, the communications link can include any combination of various types of optical fiber, wired, and/or wireless links; include any combination of one or more types of networks; and/or utilize any combination of various types of transmission techniques and protocols.

While shown and described herein as a method and system for providing vehicular directional advertisements, it is understood that aspects of the invention further provide various alternative embodiments. For example, in one embodiment, the invention provides a computer program fixed in at least one computer-readable storage medium, which when executed, enables a computer system to for providing vehicular directional advertisements. To this extent, the computer-readable storage medium includes program code, such as the advertisement selection and display program 130, which enables a computer system to implement some or all of a process described herein. It is understood that the term “computer-readable storage medium” includes one or more of any type of tangible medium of expression, now known or later developed, from which a copy of the program code can be perceived, reproduced, or otherwise communicated by a computing device. For example, the computer-readable medium can include: one or more portable storage articles of manufacture; one or more memory/storage components of a computing device; paper; and/or the like.

Another embodiment of the invention provides a method of providing a copy of program code, such as the advertisement selection and display program 130, which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

Still another embodiment of the invention provides a method for providing directional vehicular advertisements. In this case, a computer system, such as the computer system 101, can be obtained (e.g., created, maintained, made available, etc.) and one or more components for performing process(es) described herein can be obtained (e.g., created, purchased, used, modified, etc.) and deployed to the computer system. To this extent, the deployment can include one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for providing and displaying directional vehicular advertisements, comprising:
a location system for determining a location and a direction of travel of a vehicle;
at least one forward facing advertisement slot on the vehicle, wherein each forward facing advertisement slot faces oncoming traffic travelling in a direction opposite to the direction of travel of the vehicle;
a plurality of advertisements, each advertisement associated with a location; and
a controller configured to select and display at least one of the advertisements via at least one of the forward facing advertisement slots, wherein each displayed advertisement is associated with a location that the oncoming traffic has yet to pass.

2. The system for providing and displaying directional vehicular advertisements according to claim 1, wherein the controller is further configured to change at least one of the advertisements displayed via at least one of the forward facing advertisement slots based on a current location of the vehicle.

3. The system for providing and displaying directional vehicular advertisements according to claim 1, wherein the location system comprises a global positioning system (GPS) receiver.

4. The system for providing and displaying directional vehicular advertisements according to claim 1, further comprising:
at least one rearward facing advertisement slot, wherein each rearward facing advertisement slot faces traffic traveling behind and in the direction of travel of the vehicle;
wherein the controller is further configured to select and display at least one of the advertisements via at least one of the rearward facing advertisement slots, wherein the advertisement displayed by each of the rearward facing advertisement slots is associated with a location that the traffic traveling behind and in the direction of travel of the vehicle has yet to pass.

5. The system for providing and displaying directional vehicular advertisements according to claim 1, further comprising:
at least one sideways facing advertisement slot;
wherein the controller is further configured to select and display at least one of the advertisements via at least one of the sideways facing advertisement slots.

6. The system for providing and displaying directional vehicular advertisements according to claim 1, wherein each forward facing advertisement slot includes a display device for displaying digital data.

7. A method for providing and displaying directional vehicular advertisements, comprising:
determining a location and a direction of travel of a vehicle;
providing at least one forward facing advertisement slot on the vehicle, wherein each forward facing advertisement slot faces oncoming traffic travelling in a direction opposite to the direction of travel of the vehicle;
providing a plurality of advertisements, each advertisement associated with a location; and
selecting and displaying at least one of the advertisements via at least one of the forward facing advertisement slots, wherein each displayed advertisement is associated with a location that the oncoming traffic has yet to pass.

8. The method for providing and displaying directional vehicular advertisements according to claim 7, wherein the controller is further configured to change at least one of the advertisements displayed via at least one of the forward facing advertisement slots based on a current location of the vehicle.

9. The method for providing and displaying directional vehicular advertisements according to claim 7, wherein the location system comprises a global positioning system (GPS) receiver.

10. The method for providing and displaying directional vehicular advertisements according to claim 7, further comprising:
at least one rearward facing advertisement slot, wherein each rearward facing advertisement slot faces traffic traveling behind and in the direction of travel of the vehicle;
wherein the controller is further configured to select and display at least one of the advertisements via at least one of the rearward facing advertisement slots, wherein the advertisement displayed by each of the rearward facing advertisement slots is associated with a location that the traffic traveling behind and in the direction of travel of the vehicle has yet to pass.

11. The method for providing and displaying directional vehicular advertisements according to claim 7, further comprising:
at least one sideways facing advertisement slot;
wherein the controller is further configured to select and display at least one of the advertisements via at least one of the sideways facing advertisement slots.

12. The method for providing and displaying directional vehicular advertisements according to claim 7, wherein each forward facing advertisement slot includes a display device for displaying digital data.

13. A system, comprising:
a vehicle;
a location system for determining a location and a direction of travel of the vehicle;
at least one forward facing advertisement slot on the vehicle, wherein each forward facing advertisement slot faces oncoming traffic travelling in a direction opposite to the direction of travel of the vehicle;
a plurality of advertisements, each advertisement associated with a location; and
a controller configured to select and display at least one of the advertisements via at least one of the forward facing advertisement slots, wherein each displayed advertisement is associated with a location that the oncoming traffic has yet to pass.

14. The system according to claim 13, wherein the controller is further configured to change at least one of the advertisements displayed via at least one of the forward facing advertisement slots based on a current location of the vehicle.

15. The system according to claim 13, wherein the location system comprises a global positioning system (GPS) receiver.

16. The system according to claim 13, further comprising:
at least one rearward facing advertisement slot, wherein each rearward facing advertisement slot faces traffic traveling behind and in the direction of travel of the vehicle;
wherein the controller is further configured to select and display at least one of the advertisements via at least one of the rearward facing advertisement slots, wherein the advertisement displayed by each of the rearward facing advertisement slots is associated with a location that the traffic traveling behind and in the direction of travel of the vehicle has yet to pass.

17. The system according to claim 13, further comprising:
at least one sideways facing advertisement slot;
wherein the controller is further configured to select and display at least one of the advertisements via at least one of the sideways facing advertisement slots.

18. The system according to claim 13, wherein each forward facing advertisement slot includes a display device for displaying digital data.
